(19) United States
(12) Patent Application Publication
(10) Pub. No.: US 2017/0363788 A1
(43) Pub. Date: Dec. 21, 2017

(54) HEAT-RAY SHIELDING PARTICLE DISPERSING LIQUID, HEAT-RAY SHIELDING PARTICLE DISPERSING BODY, HEAT-RAY SHIELDING LAMINATED TRANSPARENT SUBSTRATE AND HEAT-RAY SHIELDING TRANSPARENT SUBSTRATE

(71) Applicant: SUMITOMO METAL MINING CO., LTD., Tokyo (JP)

(72) Inventors: Kenji Fukuda, Isa-shi (JP); Yukihiro Koyama, Isa-shi (JP)

(21) Appl. No.: 15/625,110

(22) Filed: Jun. 16, 2017

(30) Foreign Application Priority Data
Jun. 20, 2016 (JP) 2016-122080
Jun. 15, 2017 (JP) 2017-117766

(51) Int. Cl. G02B 5/24; C09D 157/06; C09D 5/32; C08J 7/04; C09D 7/12; G02B 5/20; C08K 3/22

(52) U.S. Cl. CPC G02B 5/24; C09D 7/1216; C09D 157/06; G02B 5/208; C09D 5/32; C08J 7/047; C08J 2367/02; C08J 2457/06; C08K 3/22; C08K 2003/2258

(57) ABSTRACT

A heat-ray shielding particle dispersing liquid includes heat-ray shielding particles at least containing composite tungsten oxide particles and indium tin oxide particles, the weight ratio of the composite tungsten oxide particles and the indium tin oxide particles in the heat-ray shielding particles being within a range of “composite tungsten oxide particles”/“indium tin oxide particles”=99/1 to 22/78; and a liquid medium.

### CROSS-REFERENCE TO RELATED APPLICATION

The present application is based on and claims the benefit of priority of Japanese Priority Application No. 2016-122080 filed on Jun. 20, 2016, and priority of Japanese Priority Application No. 2017-117766 filed on Jun. 15, 2017, the entire contents of which are hereby incorporated by reference.

### BACKGROUND OF THE INVENTION

### 1. Field of the Invention

The present invention relates to a heat-ray shielding particle dispersing liquid, a heat-ray shielding particle dispersing body, a heat-ray shielding laminated transparent substrate and a heat-ray shielding transparent substrate.

### 2. Description of the Related Art

Conventionally, various methods have been developed to provide heat-ray shielding properties or heat insulating properties to a portion where a heat input is generated such as a window glass in various fields such as a building like a house or the like and an automobile, for obtaining a comfortable environment while reducing energy consumption for adjusting temperature.

As one of the methods to provide the heat-ray shielding properties or the heat insulating properties to the portion where the heat input is generated such as the window glass, for example, it has been conventionally studied to provide a film or the like containing a material having heat-ray shielding properties at the window glass or the like.

When applying the film containing the material having the heat-ray shielding properties for a transparent substrate such as a window glass, in order to maintain transparency, it is preferable that visible light transmittance of the material having the heat-ray shielding properties is high. In addition to that, it is necessary for the material to have heat-ray shielding properties.

Various materials are known to be capable of transmitting visible light while having heat-ray shielding properties. For example, Patent Document 1 discloses tin oxide fine particles containing antimony and tin oxide fine particles containing indium as inorganic fine particles having heat-ray shielding properties. Patent Document 2 discloses tungsten oxide fine particles and composite tungsten oxide fine particles as fine particles having infrared ray shielding properties.

For ideal heat-ray shielding, it is required to completely shield light other than visible light. However, although the above described tin oxide fine particles containing antimony or the tin oxide fine particles containing indium, that are conventionally studied, have high transparency, in particular, absorption in a near infrared area near a visible light area is not sufficient and high heat-ray shielding properties are not obtained.

Meanwhile, the tungsten oxide fine particle and the composite tungsten oxide fine particle have high absorption properties in the near infrared area near the visible light area and high heat-ray shielding properties can be obtained. In particular, the composite tungsten oxide particles have heat-ray shielding properties.

Recently, a material having heat-ray shielding properties higher than that of the above described composite tungsten oxide fine particle or the like is required. Further, heat-ray shielding particles whose visible light transmittance is high while whose solar transmittance is reduced or a heat-ray shielding particle dispersing liquid containing such heat-ray shielding particles are required.

### PATENT DOCUMENTS

[Patent Document 1] Japanese Laid-open Patent Publication No. H8-281860
[Patent Document 2] WO 2005/037932

### SUMMARY OF THE INVENTION

The present invention is made in light of the above problems, and provides a heat-ray shielding particle dispersing liquid containing heat-ray shielding particles whose visible light transmittance is high while whose solar transmittance is reduced.

According to an embodiment, there is provided a heat-ray shielding particle dispersing liquid including heat-ray shielding particles at least containing composite tungsten oxide particles and indium tin oxide particles, the weight ratio of the composite tungsten oxide particles and the indium tin oxide particles in the heat-ray shielding particles being within a range of “composite tungsten oxide particles”/“indium tin oxide particles”=99/1 to 22/78; and a liquid medium.

### BRIEF DESCRIPTION OF THE DRAWINGS

Other objects, features and advantages of the present invention will become more apparent from the following detailed description when read in conjunction with the accompanying drawings.

FIG. 1 is a view illustrating an example of a structure of a heat-ray shielding laminated transparent substrate of an embodiment; and

FIG. 2 is a graph illustrating a relationship between percentage of composite tungsten oxide particles (Cs_{0.33}WO₃ or Rb_{0.33}WO₃) in heat-ray shielding particles used in the heat-ray shielding transparent substrate, and solar transmittance of the heat-ray shielding transparent substrate of each of examples, comparative examples and a reference example.

### DETAILED DESCRIPTION OF THE PREFERRED EMBODIMENTS

The invention will be described herein with reference to illustrative embodiments. Those skilled in the art will recognize that many alternative embodiments can be accomplished using the teachings of the present invention and that the invention is not limited to the embodiments illustrated for explanatory purposes.

It is to be noted that, in the explanation of the drawings, the same components are given the same reference numerals, and explanations are not repeated.

### (Heat-Ray Shielding Particle Dispersing Liquid)

In this embodiment, an example of a heat-ray shielding particle dispersing liquid is described.

The heat-ray shielding particle dispersing liquid of the embodiment contains heat-ray shielding particles and a liquid medium, wherein the heat-ray shielding particles at least contain composite tungsten oxide particles and indium tin oxide particles. The weight ratio of the composite tungsten oxide particles and the indium tin oxide particles in the heat-ray shielding particles may be within a range of “composite tungsten oxide particles”/“indium tin oxide particles”=99/1 to 22/78.

The present inventors investigated hard for a heat-ray shielding particle dispersing liquid containing heat-ray shielding particles whose visible light transmittance is high while whose solar transmittance is reduced. Then, the present inventors have found that heat-ray shielding particles whose visible light transmittance was high while whose solar transmittance was reduced can be obtained by adding indium tin oxide particles to be a predetermined weight ratio to composite tungsten oxide particles, whose heat-ray shielding properties are particularly good among conventionally studied particles, and mixing them, and have completed the present invention.

Hereinafter, the heat-ray shielding particle dispersing liquid of the embodiment is specifically described. As described above, the heat-ray shielding particle dispersing liquid of the embodiment may contain the heat-ray shielding particles and the liquid medium. Each component is described in the following.

### 1 Heat-Ray Shielding Particle Dispersing Liquid

### 1.1 Heat-Ray Shielding Particles

The heat-ray shielding particle dispersing liquid of the embodiment may contain the heat-ray shielding particles containing the composite tungsten oxide particles and the indium tin oxide particles. Each component is described.

### (1) Composite Tungsten Oxide Particles

As the composite tungsten oxide particles efficiently absorb light of a near infrared area, in particular, light near the wavelength of 1000 nm, transmission color mostly, becomes a blue-based color.

In the heat-ray shielding particle dispersing liquid of the embodiment, as the composite tungsten oxide particles, it is preferable to use particles containing composite tungsten oxide expressed by a general formula MₓW_{y}O_{z} (here, “M” is one or more elements selected from Cs, Rb, K, Tl, In, Ba, Li, Ca, Sr, Fe, Sn, Al and Cu, 0.1≦x≦0.5, 0.9≦y≦1.1, 2.2≦z≦3.0). Here, the composite tungsten oxide particles may be particles made of composite tungsten oxide expressed by the above described general formula.

In particular, it is preferable that the composite tungsten oxide particles include composite tungsten oxide having a hexagonal crystal structure. When the composite tungsten oxide particles include the composite tungsten oxide having the hexagonal crystal structure, visible light transmittance of the composite tungsten oxide particles can be increased and solar transmittance can be particularly reduced. Here, the composite tungsten oxide particles may be particles made of composite tungsten oxide having the hexagonal crystal structure.

Further, it is more preferable that the composite tungsten oxide particles are one or more types selected from cesium tungsten oxide particles, rubidium tungsten oxide particles and potassium tungsten oxide particles. This means that it is preferable that the composite tungsten oxide particles are one or more types selected from particles containing cesium tungsten oxide, particles containing rubidium tungsten oxide, and particles containing potassium tungsten oxide. Here, the cesium tungsten oxide particles may be particles made of cesium tungsten oxide. The rubidium tungsten oxide particles may be particles made of rubidium tungsten oxide. The potassium tungsten oxide particles may be particles made of potassium tungsten oxide.

When the composite tungsten oxide particles are one or more types selected from the cesium tungsten oxide particles, the rubidium tungsten oxide particles and the potassium tungsten oxide particles, composite tungsten oxide composing each of the particles is capable of easily having the hexagonal crystal, and the visible light transmittance of the composite tungsten oxide particles can be increased and the solar transmittance can be particularly reduced.

### (2) Indium Tin Oxide Particles

Indium tin oxide (expressed as “ITO”, “oxide indium tin” as well) is known as a transparent conductive material. Meanwhile, indium tin oxide can retain transparency at a visible light area and can absorb light greater than or equal to 1200 nm.

The indium tin oxide particles are particles containing indium tin oxide which is tin doped indium oxide. Optical properties of the indium tin oxide particles vary depending on a doped amount of tin, and it is preferable that the percentage of the weight of Sn: “Sn/(Sn+In)” is greater than or equal to 1% and less than or equal to 20%. When the percentage of the weight of Sn is greater than or equal to 1% and less than or equal to 20%, heat-ray shielding properties become particularly high and preferable. When the percentage of the weight of Sn is greater than or equal to 1%, it is possible to reduce an amount of an In component, which is expensive. The indium tin oxide particles may be particles made of indium tin oxide.

The indium tin oxide particles may contain indium tin oxide with oxygen defect (oxygen vacancy).

### 1.2 Liquid Medium

The heat-ray shielding particle dispersing liquid of the embodiment may contain the liquid medium.

As the liquid medium, for example, it is preferable to use one or more types selected from, for example, water, organic solvent, fat and oil, liquid resin and plasticizer. As the liquid medium, a mixture of two or more types selected from the above described water and the like may be used.

It is preferable that the organic solvent has a function to retain dispersion properties of the heat-ray shielding particles and a function to prevent defect in coating when coating the dispersing liquid. As the organic solvent, for example, alcohol-based solvent such as methanol (MA), ethanol (EA), 1-propanol (NPA), isopropanol (IPA), butanol, pentanol, benzyl alcohol or diacetone alcohol, ketone-based solvent such as acetone, methyl ethyl ketone (MEK), methyl propyl ketone, methyl isobutyl ketone (MIBK), cyclohexanone or isophorone, ester-based solvent such as 3-methyl-methoxy-propionate (MMP), glycol derivative such as ethylene glycol monomethyl ether (MCS), ethylene glycol monoethyl ether (ECS), ethylene glycol isopropyl ether (IPC), propylene glycol methyl ether (PGM), propylene glycol ethyl ether (PE), propylene glycol methyl ether acetate (PGMEA) or propylene glycol ethyl ether acetate (PE-AC), amides such as formamide (FA), N-methyl formamide, dimethyl formamide (DMF), dimethyl acetamide or N-methyl-2-pyrolidone (NMP), aromatic hydrocarbons such as toluene or xylen, halogenated hydrocarbons such as ethylene chloride or chlorobenzene, or the like may be raised, and one selected from them may be used or two or more selected from them may be used in combination.

Among the above, as the organic solvent, it is preferable to use organic solvent whose polarity is low. In particular, it is preferable to use one whose hydrophobic property is high such as ketone-based solvent such as MIRK or MEK, aromatic hydrocarbons such as toluene or xylen or glycol derivative such as PGMEA or PE-AC. Thus, it is preferable to use one selected from them or two or more selected from them in combination.

As the fat and oil, for example, one or more types selected from drying oil such as linseed oil, sunflower oil or wood oil, semi drying oil such as sesame oil, cotton seed oil, rapeseed oil, soybean oil or rice bran oil, non-drying oil such as olive oil, coconut oil, palm oil or dehydrated castor oil, fatty acid monoester obtained by a direct ester reaction of fatty acid of vegetable oil and monoalcohol and petroleum solvent such as ether-based, Isoper E, Exxsol Hexane, Exxsol Heptane, Exxsol E, Exxsol D30, Exxsol D40, Exxsol D60, Exxsol D80, Exxsol D95, Exxsol D110, Exxsol D130 (those manufactured by Exxon Mobil Corporation) may be used.

As the liquid resin, for example, one or more types selected from liquid acrylic resin, liquid epoxy resin, liquid polyester resin and liquid urethane resin may be used.

As the plasticizer, for example, liquid plasticizer for plastic or the like may be used.

### 1.3 Additive

The heat-ray shielding particle dispersing liquid of the embodiment may contain an optional component, in addition to the above described heat-ray shielding particles and the liquid medium.

As the optional component, for example, the heat-ray shielding particle dispersing liquid may further contain one or more types selected from dispersant, a coupling agent and a surface active agent.

The dispersant, the coupling agent or the surface active agent is selectable in accordance with a purpose, but it is preferable to use one including one or more functional groups selected from a group containing amine, a hydroxyl group, a carboxyl group and an epoxy group. These functional groups are capable of preventing aggregation of the heat-ray shielding particles, and for example, capable of uniformly dispersing the heat-ray shielding particles in the heat-ray shielding particle dispersing liquid, by adhering on a surface of each of the heat-ray shielding particles. Further, these functional groups are capable of uniformly dispersing the heat-ray shielding particles in a heat-ray shielding particle dispersing body that is manufactured by using the heat-ray shielding particle dispersing liquid as well.

As the dispersant, the coupling agent or the surface active agent, for example, a phosphate compound, a polymer-based dispersant, a silane-based coupling agent, a titanate-based coupling agent, an aluminum-based coupling agent or the like is preferably used, but not limited so. As the polymer-based dispersant, acrylic-based polymer dispersant, urethane-based polymer dispersant, acrylic-based block copolymer polymer dispersant, polyether-based dispersant, polyester-based polymer dispersant or the like may be used.

It is preferable that an adding amount of the one or more materials selected from the dispersant, the coupling agent and the surface active agent to the heat-ray shielding particle dispersing liquid is within a range of greater than or equal to 1 part by weight and less than or equal to 100 part by weight, with respect to 100 part by weight of the heat-ray shielding particles, and more preferably, greater than or equal to 5 part by weight and less than or equal to 50 part by weight. When the adding amount of the dispersant or the like, for example, is within the above range, aggregation of the heat-ray shielding particles in the dispersing liquid can be reduced and dispersing stability can be retained high.

### 1.4 Heat-Ray Shielding Particles in Heat-Ray Shielding Particle Dispersing Liquid

As described above, the heat-ray shielding particle dispersing liquid of the embodiment may contain the heat-ray shielding particles, the liquid medium, and as necessary, various optional components.

Further, by the investigation by the present inventors, it was found that solar radiation shielding properties unpredictable from each of the composite tungsten oxide particles and the indium tin oxide particles alone could be obtained while having high visible light transmittance by mixing the composite tungsten oxide particles and the indium tin oxide particles at a predetermined weight ratio and using it as the heat-ray shielding particles.

Specifically, the heat-ray shielding particles contained in the heat-ray shielding particle dispersing liquid of the embodiment may contain the composite tungsten oxide particles and the indium tin oxide particles, wherein the weight ratio of the composite tungsten oxide particles and the indium tin oxide particles in the heat-ray shielding particles may be within a range of “composite tungsten oxide particles”/“indium tin oxide particles”=99/1 to 22/78. Within such a range, solar transmittance can be furthermore reduced when being manufactured into a heat-ray shielding transparent substrate or the like, compared with a case when only the composite tungsten oxide particles are used as the heat-ray shielding particles. With this range, as can be described in examples, which will be described later, an unexpected result of reducing the solar transmittance can be obtained.

Here, the weight ratio of the composite tungsten oxide particles and the indium tin oxide particles in the heat-ray shielding particles is within a range of “composite tungsten oxide particles”/“indium tin oxide particles”=99/1 to 22/78 means that the percentage of the weight of the composite tungsten oxide particles with respect to the total of the weight of the composite tungsten oxide particles and the weight of the indium tin oxide particles in the heat-ray shielding particles is greater than or equal to 22% and less than or equal to 99%, and the rest is the indium tin oxide particles. Hereinafter, when similarly expressed, it is the same meaning.

It is more preferable that the weight ratio of the composite tungsten oxide particles and the indium tin oxide particles in the heat-ray shielding particles is within a range of “composite tungsten oxide particles”/“indium tin oxide particles”=85/15 to 30/70, and furthermore preferably, within a range of 75/25 to 35/65.

The percentage of the content of each of the heat-ray shielding particles and the liquid medium in the heat-ray shielding particle dispersing liquid is not particularly limited, but for example, it is preferable that the heat-ray shielding particle dispersing liquid contains greater than or equal to 4 part by weight and less than or equal to 94 part by weight of the liquid medium, and greater than or equal to 5 part by weight and less than or equal to 80 part by weight of the heat-ray shielding particles.

As described above, the heat-ray shielding particles mean the total of the composite tungsten oxide particles and the indium tin oxide particles. Further, as the weight ratio of the composite tungsten oxide particles and the indium tin oxide particles in the heat-ray shielding particles is already described, it is not repeated here.

As necessary, the heat-ray shielding particle dispersing liquid may further contain, for example, greater than or equal to 1 part by weight and less than or equal to 100 part by weight of one or more types selected from the dispersant, the coupling agent and the surface active agent, with respect to 100 part by weight of the heat-ray shielding particles.

A range of a mean particle size of the composite tungsten oxide particles and the indium tin oxide particles dispersed in the composite tungsten oxide particle dispersing liquid is not particularly limited, but for example, it is preferable that the mean particle size is greater than or equal to 1 nm and less than or equal to 800 nm, more preferably, greater than or equal to 1 nm and less than or equal to 200 nm, and furthermore preferably, greater than or equal to 1 nm and less than or equal to 100 nm.

When the mean particle size of the dispersed composite tungsten oxide particles and the indium tin oxide particles is less than or equal to 800 nm, near infrared ray absorption properties of the composite tungsten oxide particle and the indium tin oxide particles can be particularly increased. In other words, in such a case, solar transmittance can be particularly reduced. Further, when the mean particle size of the dispersed composite tungsten oxide particles and the indium tin oxide particles is greater than or equal to 1 nm, it is technically easy to produce.

Here, for example, for a purpose such as a windshield of an automobile for which transparency in a visible light area is particularly important, it is preferable to further consider lowering of scattering by the composite tungsten oxide particles and the indium tin oxide particles. When the lowering of scattering is important, it is preferable that the mean particle size of the dispersed composite tungsten oxide particle and the indium tin oxide particles is less than or equal to 40 nm.

Further, the mean particle size of each of the composite tungsten oxide particles and the indium tin oxide particles dispersed in the heat-ray shielding particles is not necessarily the same. However, it is preferable that the mean particle size of each of the composite tungsten oxide particles and the indium tin oxide particles dispersed in the heat-ray shielding particles is within the above described range.

### 2 Method of Manufacturing Heat-Ray Shielding Particle Dispersing Liquid

Next, an example of a method of manufacturing the heat-ray shielding particle dispersing liquid of the embodiment is described.

The method of manufacturing the heat-ray shielding particle dispersing liquid of the embodiment is not particularly limited, and it is only required to manufacture the heat-ray shielding particle dispersing liquid in which the above described heat-ray shielding particles are dispersed in the liquid medium.

The method of manufacturing the heat-ray shielding particle dispersing liquid of the embodiment may include, for example, a step of dispersing in which a source mixture of the heat-ray shielding particle dispersing liquid is dispersed using a wet medium mill such as a beads mill, a ball mill, a sand mill or a paint shaker.

In particular, as described above, it is preferable that the mean particle size of the heat-ray shielding particles dispersed in the heat-ray shielding particle dispersing liquid of the embodiment is greater than or equal to 1 nm and less than or equal to 800 nm. Thus, it is preferable to prepare the heat-ray shielding particle dispersing liquid by crushing and dispersing the heat-ray shielding particles by wet crushing using a medium agitating mill such as a beads mill.

When preparing the heat-ray shielding particle dispersing liquid of the embodiment, the composite tungsten oxide particles and the indium tin oxide particles may be dispersed at the same time as described above, but this is not limited so. For example, each of the composite tungsten oxide particles and the indium tin oxide particles may be separately dispersed in the liquid medium to prepare a composite tungsten oxide particle dispersing liquid and an indium tin oxide particle dispersing liquid. Thereafter, both dispersing liquids may be mixed at a predetermined ratio. When mixing the dispersing liquids after preparing the composite tungsten oxide particle dispersing liquid and the indium tin oxide particle dispersing liquid as such, it is preferable that each of the dispersing liquids are prepared such that a percentage of each component is within a desired range in the heat-ray shielding particle dispersing liquid after being mixed.

The heat-ray shielding particle dispersing liquid of the embodiment can contain the heat-ray shielding particles whose visible light transmittance is high while whose solar transmittance is reduced. The heat-ray shielding particles can particularly reduce the solar transmittance when the visible light transmittance of the heat-ray shielding particle dispersing liquid is high. Specifically, for example, an effect of particularly reducing the solar transmittance can be obtained when the visible light transmittance of the heat-ray shielding particle dispersing liquid is greater than or equal to 70%. If the visible light transmittance of the heat-ray shielding particle dispersing liquid is greater than or equal to 75%, the effect is more significant.

Conventionally, when mixing two types of heat-ray shielding particles whose solar transmittances are different, it was considered that the solar transmittance of obtained heat-ray shielding particles becomes a mean value of the solar transmittances of the original heat-ray shielding particles. However, according to the heat-ray shielding particles contained in the heat-ray shielding particle dispersing liquid of the embodiment, by mixing the composite tungsten oxide particles and the indium tin oxide particles at a predetermined weight ratio and using them, the solar transmittance can be furthermore reduced compared with a case when the composite tungsten oxide particles are solely used. Although why the solar transmittance can be reduced by mixing the composite tungsten oxide particles and the indium tin oxide particles is not known, it can be considered that the shielding properties to light in the near infrared area possessed by the composite tungsten oxide particles and the high transparency to the visible light possessed by the indium tin oxide particles are synergistically functioning.

### (Heat-Ray Shielding Particle Dispersing Body)

Next, an example of a heat-ray shielding particle dispersing body of the embodiment is described in the following.

The heat-ray shielding particle dispersing body of the embodiment contains heat-ray shielding particles and a binder, wherein the heat-ray shielding particles at least contain composite tungsten oxide particles and indium tin oxide particles. The weight ratio of the composite tungsten oxide particles and the indium tin oxide particles in the heat-ray shielding particles may be within a range of “composite tungsten oxide particles”/“indium tin oxide particles”=99/1 to 22/78.

The heat-ray shielding particle dispersing body of the embodiment may contain the heat-ray shielding particles and the binder. Each component is described in the following. Here, descriptions regarding the heat-ray shielding particles and the like same as those already described are not repeated.

### 1 Heat-Ray Shielding Particle Dispersing Body

### 1.1 Heat-Ray Shielding Particles

The heat-ray shielding particle dispersing body of the embodiment may contain the heat-ray shielding particles containing the composite tungsten oxide particles and the indium tin oxide particles. The heat-ray shielding particles contained in the heat-ray shielding particle dispersing body of the embodiment may have a structure same as that of the above described heat-ray shielding particles of the heat-ray shielding particle dispersing liquid.

This means, in the heat-ray shielding particle dispersing body of the embodiment, as the composite tungsten oxide particles, it is preferable to use particles containing composite tungsten oxide expressed by a general formula MₓW_{y}O_{z} (here, “M” is one or more elements selected from Cs, Rb, K, Tl, In, Ba, Li, Ca, Sr, Fe, Sn, Al and Cu, 0.1≦x≦0.5, 0.9≦y≦1.1, 2.2≦z≦3.0). Here, the composite tungsten oxide particles may be particles made of composite tungsten oxide expressed by the above described general formula.

In particular, it is preferable that the composite tungsten oxide particles include composite tungsten oxide having a hexagonal crystal structure. Here, the composite tungsten oxide particles may be particles made of composite tungsten oxide having a hexagonal crystal structure.

Further, it is more preferable that the composite tungsten oxide particles are one or more types selected from cesium tungsten oxide particles, rubidium tungsten oxide particles and potassium tungsten oxide particles. This means that it is preferable that the composite tungsten oxide particles are one or more types selected from particles containing cesium tungsten oxide, particles containing rubidium tungsten oxide, and particles containing potassium tungsten oxide. Here, the cesium tungsten oxide particles may be particles made of cesium tungsten oxide. The rubidium tungsten oxide particles may be particles made of rubidium tungsten oxide. The potassium tungsten oxide particles may be particles made of potassium tungsten oxide.

The indium tin oxide particles are particles containing indium tin oxide. The indium tin oxide particles may be particles made of indium tin oxide. As the indium tin oxide, it is preferable that the percentage of the weight of Sn: “Sn/(Sn+In)” is greater than or equal to 1% and less than or equal to 20%.

The indium tin oxide particles may contain indium tin oxide with oxygen defect (oxygen vacancy).

### 1.2 Binder

The binder is not particularly limited as long as it is possible to solidify the heat-ray shielding particles under a dispersed manner.

As the binder, one or more types of organic binders selected from ultraviolet curing resin, electron radiation curing resin, cold setting resin, thermosetting resin, thermoplastic resin and the like, one or more types of organic inorganic hybrid binders obtained by reforming the above described organic binder by one or more types of inorganic oxides selected from silicon, zirconium, titanium, aluminum and the like, or one or more types of inorganic binders obtained by polymerizing one or more types of inorganic oxides selected from silicon, zirconium, titanium, aluminum and the like, may be used.

In particular, as the binder, it is preferable to use one or more types selected from thermoplastic resin, thermosetting resin and ultraviolet curing resin. In the heat-ray shielding particle dispersing body of the embodiment, the binder may be a solid binder.

When the binder includes the thermoplastic resin, the thermoplastic resin is not particularly limited, and appropriately selected based on required transmittance, strength and the like. As the thermoplastic resin, for example, one type of resin selected from a resin group including polyethylene terephthalate resin, polycarbonate resin, acrylic resin, styrene resin, polyamide resin, polyethylene resin, vinyl chloride resin, olefin resin, epoxy resin, polyimide resin, fluororesin, ethylene-vinyl acetate copolymer and polyvinyl acetal resin, a mixture of two or more types of resins selected from the resin group, or a copolymer of two or more types of resins selected from the resin group may be preferably used.

When the binder includes ultraviolet curing resin, although the ultraviolet curing resin is not particularly limited, for example, it is preferable to use acrylic-based ultraviolet curing resin.

The content of the heat-ray shielding particles dispersedly contained in the heat-ray shielding particle dispersing body is not particularly limited, and is selectable according to its purposed or the like. It is preferable that the heat-ray shielding particle dispersing body contains the heat-ray shielding particles, for example, greater than or equal to 0.001 wt % and less than or equal to 80.0 wt %, more preferably, greater than or equal to 0.01 wt % and less than or equal to 70.0 wt %, and furthermore preferably, greater than or equal to 0.5 wt % and less than or equal to 70.0 wt %.

When the content of the heat-ray shielding particles in the heat-ray shielding particle dispersing body is greater than or equal to 0.001 wt %, it is unnecessary to make the dispersing body to be too thick in order to obtain a heat-ray shielding effect necessary for the heat-ray shielding particle dispersing body. Thus, the purpose of the heat-ray shielding particle dispersing body is not limited, and transportation is easy.

Further, when the content of the heat-ray shielding particles is less than or equal to 80.0 wt %, the content of the binder is sufficient in the heat-ray shielding particle dispersing body and strength can be retained.

As described above regarding the heat-ray shielding particle dispersing liquid, by the investigation by the present inventors, it was found that the solar radiation shielding properties unpredictable from each of the composite tungsten oxide particles and the indium tin oxide particles alone could be obtained while having high visible light transmittance by mixing the composite tungsten oxide particles and the indium tin oxide particles at a predetermined weight ratio and using them as the heat-ray shielding particles.

Thus, the heat-ray shielding particles contained in the heat-ray shielding particle dispersing body of the embodiment may contain the composite tungsten oxide particles and the indium tin oxide particles, wherein the weight ratio of the composite tungsten oxide particles and the indium tin oxide particles in the heat-ray shielding particles may be within a range of “composite tungsten oxide particles”/“indium tin oxide particles”=99/1 to 22/78. Within such a range, the solar transmittance can be furthermore reduced when being manufactured into the heat-ray shielding transparent substrate or the like, compared with a case when only the composite tungsten oxide particles are used as the heat-ray shielding particles.

It is more preferable that the weight ratio of the composite tungsten oxide particles and the indium tin oxide particles in the heat-ray shielding particles is within a range of “composite tungsten oxide particles”/“indium tin oxide particles”=85/15 to 30/70, and furthermore preferably, within a range of 75/25 to 35/65.

The heat-ray shielding particle dispersing body of the embodiment may have a selectable shape according to its purpose. The heat-ray shielding particle dispersing body may have, for example, a sheet shape, a board shape or a film shape, and may be adaptable for various purposes.

### 2. Method of Manufacturing Heat-Ray Shielding Particle Dispersing Body

An example of a method of manufacturing the heat-ray shielding particle dispersing body of the embodiment is described.

The method of manufacturing the heat-ray shielding particle dispersing body of the embodiment is not particularly limited, and it is only required to manufacture the heat-ray shielding particle dispersing body in which the above described heat-ray shielding particles are dispersed in the binder.

The heat-ray shielding particle dispersing body may be manufactured by, for example, mixing the above described binder and the heat-ray shielding particles, shaping it into a desired shape, and after that, curing it.

The heat-ray shielding particle dispersing body may be manufactured by, for example, using the above described heat-ray shielding particle dispersing liquid. For example, similar to a case for manufacturing a coating layer of a heat-ray shielding transparent substrate, which will be described later, the heat-ray shielding particle dispersing body may be manufactured by mixing the heat-ray shielding particle dispersing liquid and the binder, coating and drying it, and after that, curing the binder.

Further, dispersing powders of the heat-ray shielding particles, a plasticizer dispersing liquid or a master batch may be manufactured first, and then the heat-ray shielding particle dispersing body may be manufactured by using the dispersing powders of the heat-ray shielding particles or the like next. This is described in detail in the following.

First, a mixing step of mixing the above described heat-ray shielding particle dispersing liquid and thermoplastic resin or plasticizer may be performed. Next, a drying step of removing a solvent component from the heat-ray shielding particle dispersing liquid, in other words, the liquid medium may be performed. By removing the solvent component, when the thermoplastic resin is used, dispersing powders of the heat-ray shielding particles (hereinafter, simply referred to as “dispersing powders” as well) in which the heat-ray shielding particles are dispersed in the thermoplastic resin and/or the dispersant from the heat-ray shielding particle dispersing liquid at high concentration, can be obtained. Further, by removing the solvent component, when the plasticizer is used, a dispersing liquid (hereinafter, simply referred to as a “plasticizer dispersing liquid” as well) in which the heat-ray shielding particles are dispersed in the plasticizer at high concentration can be obtained.

The method of removing the solvent component from the mixture of the heat-ray shielding particle dispersing liquid and the thermoplastic resin or the plasticizer is not particularly limited, but for example, it is preferable to use a method of drying the mixture under reduced pressure. Specifically, it is possible to separate the dispersing powders or the plasticizer dispersing liquid, and the solvent component by drying the mixture under reduced pressure while agitating. As a device used for drying under reduced pressure, a vacuum agitating drying machine may be used. However, the device is not particularly limited as long as the device has the above described functions. Further, a reduced pressure value in the drying step is not particularly limited, and may be appropriately selected.

By using the method of dying under reduced pressure when removing the solvent component, the solvent component can be effectively removed from the mixture. Further, when the method of dying under reduced pressure is used, the dispersing powders of the heat-ray shielding particles or the plasticizer dispersing liquid are prevented from being exposed to high temperature for a long period. Thus, it is preferable because aggregation of the heat-ray shielding particles dispersed in the heat-ray shielding particles dispersing powders or the plasticizer dispersing liquid does not occur. Further, productivity of the dispersing powders of the heat-ray shielding particles or the plasticizer dispersing liquid is also increased. Furthermore, it is preferable from an environmental point of view as the vaporized solvent can be easily recovered.

It is preferable that the remaining solvent component is less than or equal to 5 wt % in the dispersing powders of the heat-ray shielding particles or the plasticizer dispersing liquid obtained after performing the drying step. When the remaining solvent component is less than or equal to 5 wt %, air bubbles are not generated when manufacturing the heat-ray shielding laminated transparent substrate, which will be described later, or the like, for example, using the dispersing powders of the heat-ray shielding particles or the plasticizer dispersing liquid, and an appearance and optical properties are retained good.

Further, as described above, the master batch may be used when manufacturing the heat-ray shielding particle dispersing body.

The master batch may be manufactured by, for example, dispersing the heat-ray shielding particle dispersing liquid or the dispersing powders of the heat-ray shielding particles in resin, and pelletizing the resin.

As another method of manufacturing the master batch, first, the heat-ray shielding particle dispersing liquid or the dispersing powders of the heat-ray shielding particles are uniformly mixed with particulate objects or pellets of thermoplastic resin, and as necessary, another additive. Then, the mixture is kneaded by a vented single screw or double screw extruder, and formed into pellets by a general method of cutting the melted and extruded strand. With this, the master batch is manufactured. In such a case, the shape of the pellet may be a cylindrical shape or a prismatic shape. Further, a so-called hot cut method, by which the melted and extruded objects are directly cut may be used. In such a case, it is general for the pellet to have a shape nearly spherical shape.

By the above steps, the dispersing powders of the heat-ray shielding particles, the plasticizer dispersing liquid, or the master batch are manufactured.

Then, the heat-ray shielding particle dispersing body of the embodiment may be manufactured by uniformly mixing the dispersing powders of the heat-ray shielding particles, the plasticizer dispersing liquid or the master batch in the binder, and shaping the mixture into a desired shape. At this time, as the binder, as described above, an inorganic binder, an organic inorganic hybrid binder or an organic binder such as resin may be used. It is preferable, in particular, to use one or more types selected from thermoplastic resin, thermosetting resin and ultraviolet curing resin as the binder. The thermoplastic resin, the thermosetting resin and the ultraviolet curing resin that are particularly preferably used are already described, and are not repeated here.

When the thermoplastic resin is used as the binder, the dispersing powders of the heat-ray shielding particles, the plasticizer dispersing liquid or the master batch, the thermoplastic resin, and according to necessity, a plasticizer and another additive may be kneaded first. Then, the heat-ray shielding particle dispersing body shaped into a planar shape or a curved plate shape having a sheet shape, a board shape or a film shape may be manufactured from the kneaded object by various forming methods such as extrusion molding, injection molding, a calender roll method, extruding, casting or inflation molding.

When the heat-ray shielding particle dispersing body in which the thermoplastic resin is used as the binder is used as an intermediate film that is placed between transparent substrates and the like, for example, and if the thermoplastic resin contained in the heat-ray shielding particle dispersing body does not have sufficient flexibility or adhesion with the transparent substrates and the like, it is preferable to add a plasticizer when manufacturing the heat-ray shielding particle dispersing body. Specifically, for example, when the thermoplastic resin is polyvinyl acetal resin, it is preferable to further add a plasticizer.

The plasticizer to be added is not particularly limited, and any materials capable of functioning as a plasticizer for the thermoplastic resin to be used may be used. For example, when polyvinyl acetal resin is used as the thermoplastic resin, it is preferable to use a plasticizer of a compound of monohydric alcohol and organic ester, an ester-based plasticizer such as a polyalcohol organic ester compound, a phosphate-based plasticizer such as an organic phosphate-based plasticizer, or the like as the plasticizer.

It is preferable that the plasticizer is liquid at room temperature. Thus, it is more preferable to use an ester compound synthesized from polyalcohol and fatty acid.

Then, as described above, the heat-ray shielding particle dispersing body of the embodiment may have a selectable shape, and for example, may have a sheet shape, a board shape or a film shape.

The heat-ray shielding laminated transparent substrate, the heat-ray shielding transparent substrate or the like, which will be described later, may be manufactured by using the heat-ray shielding particle dispersing body having the sheet shape, the board shape or the film shape.

The above described heat-ray shielding particle dispersing body of the embodiment can contain the heat-ray shielding particles whose visible light transmittance is high while whose solar transmittance is reduced. The heat-ray shielding particles can particularly reduce solar transmittance when the visible light transmittance of the heat-ray shielding particle dispersing body is high. Specifically, for example, an effect of particularly reducing the solar transmittance can be obtained when the visible light transmittance of the heat-ray shielding particle dispersing body is greater than or equal to 70%. If the visible light transmittance of the heat-ray shielding particle dispersing body is greater than or equal to 75%, the effect is more significant.

Then, according to the heat-ray shielding particles contained in the heat-ray shielding particle dispersing body of the embodiment, by mixing the composite tungsten oxide particles and the indium tin oxide particles at a predetermined weight ratio and using them, the solar transmittance can be furthermore reduced compared with a case when the composite tungsten oxide particles are solely used. Although why the solar transmittance can be reduced by mixing the composite tungsten oxide particles and the indium tin oxide particles is not known, it can be considered that the shielding properties to light in the near infrared area possessed by the composite tungsten oxide particles and the high transparency to the visible light possessed by the indium tin oxide particles are synergistically functioning.

### (Heat-Ray Shielding Laminated Transparent Substrate)

Next, an example of a heat-ray shielding laminated transparent substrate of the embodiment is described.

The heat-ray shielding laminated transparent substrate (base material) of the embodiment includes a plurality of transparent substrates, and the above described heat-ray shielding particle dispersing body, wherein the heat-ray shielding particle dispersing body is positioned between the transparent substrates.

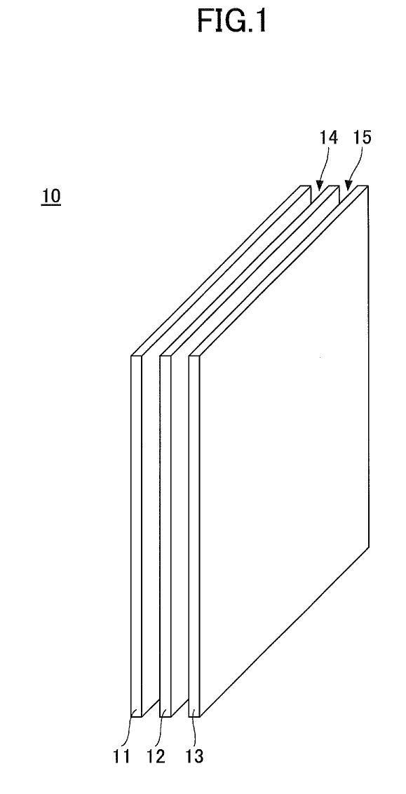

The heat-ray shielding laminated transparent substrate of the embodiment is described with reference to FIG.1. FIG.1 is a perspective view of a heat-ray shielding laminated transparent substrate 10 of the embodiment. However, the heat-ray shielding particle dispersing body is not illustrated in FIG. 1.

As illustrated in FIG. 1, the heat-ray shielding laminated transparent substrate 10 may include a plurality of transparent substrates 11, 12 and 13. Here, although an example in which three transparent substrates 11 to 13 are used is illustrated in FIG. 1, this is not limited so. The heat-ray shielding laminated transparent substrate 10 may include two or four or more of the transparent substrates. As illustrated in FIG. 1, the plurality of the transparent substrates 11 to 13 may be placed such that their main surfaces are in parallel with each other.

The heat-ray shielding particle dispersing body, not illustrated in the drawings, may be placed to be in parallel with the plurality of the transparent substrates 11 to 13 as well. Then, in this example, two of the heat-ray shielding particle dispersing body, not illustrated in the drawings, may be placed at positions (spaces) 14 and 15 between the transparent substrates, respectively.

The number of the heat-ray shielding particle dispersing bodies included in the heat-ray shielding laminated transparent substrate 10 is not particularly limited, and the heat-ray shielding particle dispersing bodies may be provided in accordance with the number of positions between the plurality of the transparent substrates. For example, for the case of the heat-ray shielding laminated transparent substrate 10 illustrated in FIG. 1, there are positions 14 and 15 between the transparent substrates. Thus, the heat-ray shielding particle dispersing bodies may be provided at both of the positions 14 and 15, respectively. Alternatively, the heat-ray shielding particle dispersing body may be provided at one of the positions 14 and 15. In other words, the heat-ray shielding particle dispersing body may be placed at one or more selected spaces between the transparent substrates, among the spaces between the transparent substrates. Thus, the heat-ray shielding particle dispersing body functions as an intermediate film.

When there is a space at which the heat-ray shielding particle dispersing body is not provided, among the spaces between the transparent substrates included in the heat-ray shielding laminated transparent substrate, a structure of the space is not particularly limited. For example, an ultraviolet absorbing film or a heat-ray shielding particle dispersing body having a different structure, or the like may be provided.

By the investigation by the present inventors, the composite tungsten oxide particles contained in the heat-ray shielding particles contained in the heat-ray shielding particle dispersing body of the intermediate film are oxidized and color of the heat-ray shielding particle dispersing body containing the composite tungsten oxide particles may be deteriorated, when being left under a severe environment of high temperature and high humidity for a long time. However, by configuring the heat-ray shielding laminated transparent substrate 10 as illustrated in FIG. 1, as the heat-ray shielding particle dispersing body, which is the intermediate film, is positioned between the substrates. Thus, the composite tungsten oxide particles and the like contained in the heat-ray shielding particle dispersing body, which is the intermediate film, can be prevented from being exposed to air. Thus, even when being left under a severe environment of high temperature and high humidity for a long time, for example, deterioration of color of the heat-ray shielding particle dispersing body, which is the intermediate film, due to oxidization of the composite tungsten oxide particles can be reduced.

Hereinafter, the transparent substrates and the heat-ray shielding particle dispersing body, which is the intermediate film, included in the heat-ray shielding laminated transparent substrate of the embodiment are described.

As the heat-ray shielding particle dispersing body of the heat-ray shielding laminated transparent substrate of the embodiment, the above described heat-ray shielding particle dispersing body may be used. In such a case, the binder is not particularly limited, and for example, polyvinyl acetal resin may be used. A method of manufacturing the heat-ray shielding particle dispersing body when the polyvinyl acetal resin is used as the binder is described in the following.

The heat-ray shielding particle dispersing body that contain the composite tungsten oxide particles and the indium tin oxide particles as the heat-ray shielding particles, and the polyvinyl acetal resin as the binder may be manufactured by, for example, using the plasticizer dispersing liquid in which the composite tungsten oxide particles and the indium tin oxide particles are dispersed in the plasticizer. This is described in detail in the following.

When manufacturing the plasticizer dispersing liquid, first, a mixing step of mixing the above described heat-ray shielding particle dispersing liquid and the plasticizer may be performed. Next, a drying step of removing a solvent component from the heat-ray shielding particle dispersing liquid, in other words, the liquid medium may be performed. By removing the solvent component, the plasticizer dispersing liquid in which the heat-ray shielding particles are dispersed in the plasticizer at high concentration can be obtained.

The method of removing the solvent component from the mixture of the heat-ray shielding particle dispersing liquid and the plasticizer is not particularly limited, but for example, it is preferable to use a method of drying the mixture of the heat-ray shielding particle dispersing liquid and the plasticizer under reduced pressure. Specifically, it is possible to separate the plasticizer dispersing liquid and the solvent component by drying the mixture of the heat-ray shielding particle dispersing liquid and the plasticizer under reduced pressure while agitating. As a device used for drying under reduced pressure, a vacuum agitating drying machine may be used. However, the device is not particularly limited as long as the device has the above described functions. Further, a reduced pressure value in the drying step is not particularly limited, and may be appropriately selected.

It is preferable that the remaining solvent component is less than or equal to 5 wt % in the plasticizer dispersing liquid obtained after performing the drying step. When the remaining solvent component is less than or equal to 5 wt %, air bubbles are not generated when manufacturing the heat-ray shielding laminated transparent substrate using the plasticizer dispersing liquid, and an appearance and optical properties are retained good.

Further, it is preferable that the concentration of the heat-ray shielding particles in the plasticizer dispersing liquid is greater than or equal to 5 wt % and less than or equal to 50 wt %. When the concentration of the heat-ray shielding particles is less than or equal to 50 wt %, aggregation of the heat-ray shielding particles can be prevented, the heat-ray shielding particles can be easily dispersed, drastic increase of the viscosity can be prevented, and the plasticizer dispersing liquid can be easily handled. Further, when the concentration of the heat-ray shielding particles in the plasticizer dispersing liquid is greater than or equal to 5 wt %, both of a manufacturing efficiency of the plasticizer dispersing liquid and dispersion of the heat-ray shielding particles can be obtained.

As the plasticizer preferably used for a case when the polyvinyl acetal resin is used as the binder is already described, it is not repeated.

Further, the plasticizer dispersing liquid may be prepared by directly dispersing the heat-ray shielding particles in the plasticizer, without using the heat-ray shielding particle dispersing liquid as described above.

A method of uniformly dispersing the heat-ray shielding particles in the plasticizer in the mixture of the plasticizer and the heat-ray shielding particles is selectable. As a specific example, a method such as a beads mill, a ball mill, a sand mill or supersonic dispersion may be used. As necessary, dispersant or the like may be added.

Then, after mixing and kneading the obtained plasticizer dispersing liquid and the polyvinyl acetal resin, the mixture is shaped into a film shape, for example, by a method such as extrusion molding, injection molding, calender roll, extruding, casting or inflation molding, and the heat-ray shielding particle dispersing body, which becomes the intermediate film, is manufactured. When kneading the plasticizer dispersing liquid and the polyvinyl acetal resin, as necessary, plasticizer, adhesion adjustor or another additive may be added and then may be mixed and kneaded.

As the polyvinyl acetal resin, polyvinyl butyral resin is preferably used. Further, based on physical properties of the intermediate film, a plurality of types of polyvinyl acetal resin whose degrees of acetalization are different may be used in combination. Further, it is preferable to use polyvinyl acetal resin obtained by reacting a plurality of types of aldehydes in combination in acetalizing. Here, it is preferable that degree of acetalization of the polyvinyl acetal resin is greater than or equal to 60%. It is preferable that the degree of acetalization of the polyvinyl acetal resin is less than or equal to 75%.

The method of manufacturing the heat-ray shielding particle dispersing body, which is the intermediate film used for the heat-ray shielding laminated transparent substrate of the embodiment, is described in which the polyvinyl acetal resin is used as the binder. However, the binder is not limited to the polyvinyl acetal resin. For example, various binders described for the heat-ray shielding particle dispersing body may be used as well. Further, for the method of manufacturing the heat-ray shielding particle dispersing body, various methods of manufacturing described for the heat-ray shielding particle dispersing body may be used.

Then, as described above, the heat-ray shielding laminated transparent substrate of the embodiment may be manufactured by providing the heat-ray shielding particle dispersing body, which is the intermediate film, between a plurality of the transparent substrates, and integrally adhering them.

The transparent substrate is not particularly limited, but for example, a glass substrate or the like made of a glass material, or a resin substrate (a plastic substrate) or the like made of a resin material is preferable used.

The thickness of the transparent substrate is selectable in accordance with a material or the like of the transparent substrate, and is not particularly limited. However, for example, when the transparent substrate is the resin substrate, the thickness may be greater than or equal to 3 μm. When the transparent substrate is the resin substrate and when the thickness is greater than or equal to 3 μm, sufficient strength can be obtained.

When the transparent substrate is the resin substrate, the upper limit value of the thickness is not particularly limited, but may be less than or equal to 100 μm in a point of view of handling or the like.

Further, when the transparent substrate is the glass substrate, the thickness of the glass substrate may be greater than or equal to 1 mm. When the thickness of the glass substrate is greater than or equal to 1 mm, sufficient strength can be obtained.

When the transparent substrate is the glass substrate, the upper limit value of the thickness is not particularly limited, but may be less than or equal to 5 mm, for example. When the thickness of the glass substrate is less than or equal to 5 mm, the glass substrate is not heavy and handling is easy.

The transparent substrate may be a single layer or may be made of a plurality of layers. When the transparent substrate is made of a plurality of layers, it is preferable that each of the layers satisfies the above range.

Further, a surface treatment may be performed on a surface of the transparent substrate such as a physical treatment such as corona discharge processing or plasma processing or a chemical treatment such as undercoating, for example.

It is preferable that the transparent substrate has high transparency. For example, it is preferable that the total light transmittance at a visible light wavelength area of the transparent substrate evaluated based on JIS K 7361-1 is greater than or equal to 85%, more preferably, greater than or equal to 88%, and furthermore preferably, greater than or equal to 90%.

Further, it is preferable that the haze of the transparent substrate evaluated based on JIS K 7136 is, for example, less than or equal to 1.5%, and more preferably, less than or equal to 1.0%.

In particular, in order to sufficiently increase the visible light transmittance and increase weatherproof of the heat-ray shielding laminated transparent substrate of the embodiment, it is preferable that at least one of the plurality of the transparent substrates is a glass substrate.

It is preferable that the visible light transmittance of the heat-ray shielding laminated transparent substrate of the embodiment is greater than or equal to 70%, and also the solar transmittance of the heat-ray shielding laminated transparent substrate of the embodiment is lower than that of a comparative heat-ray shielding laminated transparent substrate in which only the composite tungsten oxide particles are used as the heat-ray shielding particles, and whose visible light transmittance is the same as that of the heat-ray shielding laminated transparent substrate of the embodiment.

Here, the visible light transmittance of such a comparative heat-ray shielding laminated transparent substrate in which only the composite tungsten oxide particles are used as the heat-ray shielding particles may be adjusted to be the same as that of the heat-ray shielding laminated transparent substrate of the embodiment by adjusting the thickness of the heat-ray shielding particle dispersing body, which is the intermediate film, for example. Further, it is preferable that such a comparative heat-ray shielding laminated transparent substrate in which only the composite tungsten oxide particles are used as the heat-ray shielding particles is similarly configured as the heat-ray shielding laminated transparent substrate of the embodiment except that the type of the heat-ray shielding particles is different and adjustment is performed for making the visible light transmittance to be the same as that of the heat-ray shielding laminated transparent substrate of the embodiment.

However, when manufacturing the heat-ray shielding laminated transparent substrate of the embodiment and the comparative heat-ray shielding laminated transparent substrate whose visible light transmittance is the same as that of the heat-ray shielding laminated transparent substrate of the embodiment, it is difficult to completely match the visible light transmittances of them. Thus, each of the heat-ray shielding laminated transparent substrates may be manufactured such that its visible light transmittance becomes within a range of ±0.5% of a target value and then may be compared. In other words, in the heat-ray shielding laminated transparent substrate of the embodiment, it is preferable that the visible light transmittance of the heat-ray shielding laminated transparent substrate of the embodiment is within a range of ±0.5% of target visible light transmittance, and also the solar transmittance of the heat-ray shielding laminated transparent substrate of the embodiment is lower than that of the comparative heat-ray shielding laminated transparent substrate in which only the composite tungsten oxide particles are used as the heat-ray shielding particles, and whose visible light transmittance is within a range of ±0.5% of the target visible light transmittance. At this time, the target visible light transmittance may be greater than or equal to 70%.

As another example of the heat-ray shielding laminated transparent substrate, a structure in which the heat-ray shielding particle dispersing body is formed on one of the transparent substrates as the intermediate film, and the heat-ray shielding particle dispersing body is sandwiched by the other of the transparent substrates via an optionally selected intermediate film may be provided. In other words, the optionally selected intermediate film other than the heat-ray shielding particle dispersing body may be provided between the plurality of the transparent substrates in addition to the heat-ray shielding particle dispersing body, which is the intermediate film. As the optionally selected intermediate film, an ultraviolet absorbing film or the like may be used, for example.

A purpose to use the heat-ray shielding laminated transparent substrate of the embodiment is not particularly limited, but for example, the heat-ray shielding laminated transparent substrate of the embodiment may be used as a windshield of an automobile or a window of a building.

The above described heat-ray shielding laminated transparent substrate of the embodiment can contain the heat-ray shielding particles whose visible light transmittance is high while whose solar transmittance is reduced in the intermediate film, which is the heat-ray shielding particle dispersing body. The heat-ray shielding particles can particularly reduce the solar transmittance when the visible light transmittance of the heat-ray shielding particle dispersing body is high. Specifically, for example, an effect of particularly reducing the solar transmittance can be obtained when the visible light transmittance of the heat-ray shielding particle dispersing body is greater than or equal to 70%. If the visible light transmittance of the heat-ray shielding particle dispersing body is greater than or equal to 75%, the effect is more significant.

Then, according to the heat-ray shielding particles contained in the intermediate film of the heat-ray shielding laminated transparent substrate of the embodiment, by mixing the composite tungsten oxide particles and the indium tin oxide particles at a predetermined weight ratio and using them, the solar transmittance can be furthermore reduced compared with a case when the composite tungsten oxide particles are solely used. Although why solar transmittance can be reduced by mixing the composite tungsten oxide particles and the indium tin oxide particles is not known, it can be considered that the shielding properties to light in the near infrared area possessed by the composite tungsten oxide particles and the high transparency to visible light possessed by the indium tin oxide particles are synergistically functioning.

### (Heat-Ray Shielding Transparent Substrate)

Next, an example of a heat-ray shielding transparent substrate of the embodiment is described.

The heat-ray shielding transparent substrate of the embodiment may have a structure in which a coating layer (the heat-ray shielding particle dispersing body) containing heat-ray shielding particles and a binder is provided on at least one surface of a transparent substrate, which is a resin substrate or a glass substrate. Then, the heat-ray shielding particles contain at least composite tungsten oxide particles and indium tin oxide particles, wherein the weight ratio of the composite tungsten oxide particles and the indium tin oxide particles in the heat-ray shielding particles may be within a range of “composite tungsten oxide particles”/“indium tin oxide particles”=99/1 to 22/78.

The heat-ray shielding transparent substrate of the embodiment may contain the heat-ray shielding particles containing the composite tungsten oxide particles and the indium tin oxide particles. The heat-ray shielding particles contained in the heat-ray shielding transparent substrate of the embodiment may be the same as the heat-ray shielding particles of the above described heat-ray shielding particle dispersing liquid.

This means, in the coating layer of the heat-ray shielding transparent substrate of the embodiment, as the composite tungsten oxide particles, it is preferable to use particles containing composite tungsten oxide expressed by a general formula MₓW_{y}O_{z} (here, “M” is one or more elements selected from Cs, Rb, K, Tl, In, Ba, Li, Ca, Sr, Fe, Sn, Al and Cu, 0.1≦x≦0.5, 0.9≦y≦1.1, 2.2≦z≦3.0). Here, the composite tungsten oxide particles may be particles made of composite tungsten oxide expressed by the above described general formula.

In particular, it is preferable that the composite tungsten oxide particles include composite tungsten oxide having a hexagonal crystal structure. Here, the composite tungsten oxide particles may be particles made of composite tungsten oxide having a hexagonal crystal structure.

Further, it is more preferable that the composite tungsten oxide particles are one or more types selected from cesium tungsten oxide particles, rubidium tungsten oxide particles and potassium tungsten oxide particles. This means that it is preferable that the composite tungsten oxide particles are one or more types selected from particles containing cesium tungsten oxide, particles containing rubidium tungsten oxide, and particles containing potassium tungsten oxide. Here, the cesium tungsten oxide particles may be particles made of cesium tungsten oxide. The rubidium tungsten oxide particles may be particles made of rubidium tungsten oxide. The potassium tungsten oxide particles may be particles made of potassium tungsten oxide.

The indium tin oxide particles are particles containing indium tin oxide. The indium tin oxide particles may be particles made of indium tin oxide. As the indium tin oxide, it is preferable that the percentage of the weight of Sn: “Sn/(Sn+In)” is greater than or equal to 1% and less than or equal to 20%.

The indium tin oxide particles may contain indium tin oxide with oxygen defect (oxygen vacancy).

As described above regarding the heat-ray shielding particle dispersing liquid, by the investigation by the present inventors, it was found that the solar radiation shielding properties unpredictable from each of the composite tungsten oxide particles and the indium tin oxide particles alone could be obtained while having high visible light transmittance by mixing the composite tungsten oxide particles and the indium tin oxide particles at a predetermined weight ratio and using them as the heat-ray shielding particles.

Thus, the heat-ray shielding particles contained in the coating layer of the heat-ray shielding transparent substrate of the embodiment may contain the composite tungsten oxide particles and the indium tin oxide particles, wherein the weight ratio of the composite tungsten oxide particles and the indium tin oxide particles in the heat-ray shielding particles may be within a range of “composite tungsten oxide particles”/“indium tin oxide particles”=99/1 to 22/78. Within such a range, the solar transmittance can be furthermore reduced, compared with a case when only the composite tungsten oxide particles are used as the heat-ray shielding particles.

It is more preferable that the weight ratio of the composite tungsten oxide particles and the indium tin oxide particles in the heat-ray shielding particles is within a range of “composite tungsten oxide particles”/“indium tin oxide particles”=85/15 to 30/70, and furthermore preferably, within a range of 75/25 to 35/65.

The binder is not particularly limited, and the inorganic binder, the organic inorganic hybrid binder or the organic binder such as the resin, which is already described regarding the heat-ray shielding particle dispersing body may be used, for example. It is preferable, in particular, to use ultraviolet curing resin as the binder. The ultraviolet curing resin that is particularly preferably used is already described regarding the heat-ray shielding particle dispersing body, and is not repeated here.

The content of the heat-ray shielding particles dispersedly contained in the coating layer is not particularly limited, and is selectable according to its purposed or the like. It is preferable that the content of the heat-ray shielding particles contained in the coating layer is, for example, greater than or equal to 0.001 wt % and less than or equal to 80.0 wt %, more preferably, greater than or equal to 0.01 wt % and less than or equal to 70.0 wt %, and furthermore preferably, greater than or equal to 0.5 wt % and less than or equal to 70.0 wt %.

When the content of the heat-ray shielding particles in the coating layer is greater than or equal to 0.001 wt %, it is unnecessary to make the coating layer to be too thick in order to obtain a heat-ray shielding effect necessary for the coating layer. Thus, the purpose of the coating layer is not limited, and transportation is easy.

Further, when the content of the heat-ray shielding particles is less than or equal to 80.0 wt %, the content of the binder is sufficient in the coating layer and strength can be retained.

As the transparent substrate, as described above, a resin substrate (plastic substrate), a glass substrate made of a glass material or the like is preferably used.

In particular, as the transparent substrate, although depending on a purpose or the like, for example, a resin substrate is preferably used. As the resin substrate, a resin substrate appropriate for the purpose may be selected, and is not particularly limited. As the resin substrate, colorless and transparent resin capable of transmitting visible light with less scattering is preferably used, and for example, polycarbonate-based resin, polymethacrylic ester-based resin, cyclic olefin-based resin, saturated polyester-based resin, a transparent substrate such as polystyrene, polyvinyl chloride or polyvinyl acetate, or the like may be raised. In particular, as the resin substrate, a polyester film is preferably used, and a polyethylene terephthalate (PET) film is furthermore preferably used.

The thickness of the transparent substrate is selectable in accordance with a material or the like of the transparent substrate, and is not particularly limited. However, for example, when the transparent substrate is the resin substrate, the thickness may be greater than or equal to 3 μm. When the transparent substrate is the resin substrate and when the thickness is greater than or equal to 3 μm, sufficient strength can be obtained.

when the transparent substrate is the resin substrate, the upper limit value of the thickness is not particularly limited, but may be less than or equal to 100 μm in a point of view of handling or the like.

Further, when the transparent substrate is the glass substrate, the thickness of the glass substrate may be greater than or equal to 1 mm. When the thickness of the glass substrate is greater than or equal to 1 mm, sufficient strength can be obtained.

When the transparent substrate is the glass substrate, the upper limit value of the thickness is not particularly limited, but may be less than or equal to 5 mm, for example. When the thickness of the glass substrate is less than or equal to 5 mm, the glass substrate is not heavy and handling is easy.

The transparent substrate may be a single layer or may be made of a plurality of layers. When the transparent substrate is made of a plurality of layers, it is preferable that each of the layers satisfies the above range.

Further, a surface treatment may be performed on a surface of the transparent substrate such as a physical treatment such as corona discharge processing or plasma processing or a chemical treatment such as undercoating, for example.

It is preferable that the transparent substrate has high transparency. For example, it is preferable that the total light transmittance at a visible light wavelength area of the transparent substrate evaluated based on JIS K 7361-1 is greater than or equal to 85%, more preferably, greater than or equal to 88%, and furthermore preferably, greater than or equal to 90%.

Further, it is preferable that the haze of the transparent substrate evaluated based on JIS K 7136 is, for example, less than or equal to 1.5%, and more preferably, less than or equal to 1.0%.

It is preferable that the visible light transmittance of the heat-ray shielding transparent substrate of the embodiment is greater than or equal to 70%, and also the solar transmittance of the heat-ray shielding transparent substrate of the embodiment is lower than that of a comparative heat-ray shielding transparent substrate in which only the composite tungsten oxide particles are used as the heat-ray shielding particles, and whose visible light transmittance is the same as that of the heat-ray shielding transparent substrate of the embodiment.

Here, the visible light transmittance of such a comparative heat-ray shielding transparent substrate in which only the composite tungsten oxide particles are used as the heat-ray shielding particles may be adjusted to be the same as that of the heat-ray shielding transparent substrate of the embodiment by adjusting the thickness of the heat-ray shielding particle dispersing body, which is the coating layer, for example. Further, it is preferable that such a comparative heat-ray shielding transparent substrate in which only the composite tungsten oxide particles are used as the heat-ray shielding particles is similarly configured as the heat-ray shielding transparent substrate of the embodiment except that the type of the heat-ray shielding particles is different and adjustment is performed for making the visible light transmittance to be the same as that of the heat-ray shielding transparent substrate of the embodiment.

However, when manufacturing the heat-ray shielding transparent substrate of the embodiment and the comparative heat-ray shielding transparent substrate whose visible light transmittance is the same as that of the heat-ray shielding transparent substrate of the embodiment, it is difficult to completely match the visible light transmittances of them. Thus, each of the heat-ray shielding transparent substrates may be manufactured such that its visible light transmittance becomes within a range of ±0.5% of a target value and then may be compared. In other words, in the heat-ray shielding transparent substrate of the embodiment, it is preferable that the visible light transmittance of the heat-ray shielding transparent substrate of the embodiment is within a range of ±0.5% of target visible light transmittance, and also the solar transmittance of the heat-ray shielding transparent substrate of the embodiment is lower than that of the comparative heat-ray shielding transparent substrate in which only the composite tungsten oxide particles are used as the heat-ray shielding particles, and whose visible light transmittance is within a range of ±0.5% of the target visible light transmittance. At this time, the target visible light transmittance may be greater than or equal to 70%.

Next, an example of a method of manufacturing the heat-ray shielding transparent substrate of the embodiment is described.

The method of manufacturing the heat-ray shielding transparent substrate may include a step of preparing coating liquid in which the coating liquid is prepared by mixing the binder and the heat-ray shielding particle dispersing liquid, or mixing the binder and the heat-ray shielding particles. Then, the method may include a coating step in which the coating liquid is coated on the transparent substrate, and a drying and curing step in which the coating liquid coated on the transparent substrate is dried and cured.

When preparing the coating liquid, as necessary, solvent may be added.

A method of coating the coating liquid on the transparent substrate is not particularly limited, and any methods capable of coating the coating liquid in a flat, thin and uniform manner may be used such as dipping, flow coating, spraying, bar coating, spin coating, gravure coating, roll coating, screen printing or blade coating. The thickness of the coating layer formed on the transparent substrate is not particularly limited, but preferably, less than or equal to 10 μm, and more preferably, less than or equal to 6 μm. When the thickness of the coating layer is less than or equal to 10 μm, defects in processing such as warping of the transparent substrate can be suppressed when vaporizing solvent from the coating layer and curing the binder, in addition to that the coating layer can show sufficient pencil hardness and has rubfastness.

Further, a method of curing the coating liquid coated on the transparent substrate is selectable based on the type of the binder. When the binder is ultraviolet curing resin, an ultraviolet lamp may be selected in accordance with resonant wavelength of each photo-initiator or a target curing speed. As a typical lamp, a low pressure mercury lamp, a high pressure mercury lamp, an extra-high pressure mercury lamp, a metal halide lamp, a pulse xenon lamp, an electrodeless discharge lamp or the like may be raised. For electron radiation curing type resin binder for which photo-initiator is not used, the binder may be cured by using an electron beam irradiation apparatus of a scanning type, an electron-curtain type or the like. For the thermosetting resin binder, the resin may be cured at target temperature, and for the cold setting resin, the resin may be cured by just leaving it after coating.

Here, although an example in which the heat-ray shielding transparent substrate is manufactured by preparing the coating liquid, and coating, drying and curing the coating liquid is described, this is not limited so. For example, the heat-ray shielding transparent substrate may be manufacture by coating the heat-ray shielding particle dispersing liquid on the transparent substrate, further coating a binder on a surface of the coated heat-ray shielding particle dispersing liquid thereafter, and drying and curing it.

The above described heat-ray shielding transparent substrate of the embodiment may contain the heat-ray shielding particles whose visible light transmittance is high while whose solar transmittance is reduced in the coating layer. The heat-ray shielding particles can particularly reduce the solar transmittance when visible light transmittance of the heat-ray shielding transparent substrate is high. Specifically, for example, an effect of particularly reducing the solar transmittance can be obtained when the visible light transmittance of the heat-ray shielding transparent substrate is greater than or equal to 70%. If the visible light transmittance of the heat-ray shielding transparent substrate is greater than or equal to 75%, the effect is more significant.

Then, according to the heat-ray shielding particles contained in the coating layer of the heat-ray shielding transparent substrate of the embodiment, by mixing the composite tungsten oxide particles and the indium tin oxide particles at a predetermined weight ratio and using them, the solar transmittance can be furthermore reduced compared with a case when the composite tungsten oxide particles are solely used. Although why solar transmittance can be reduced by mixing the composite tungsten oxide particles and the indium tin oxide particles is not known, it can be considered that the shielding properties to light in the near infrared area possessed by the composite tungsten oxide particles and the high transparency to visible light possessed by the indium tin oxide particles are synergistically functioning.

### EXAMPLES

The present invention is specifically described with reference to examples. However, the present invention is not limited to the examples in the following.

The visible light transmittance and the solar transmittance of the heat-ray shielding transparent substrate of each example, each comparative example and a reference example in the following were measured in accordance with ISO 9050 and JIS R 3106. Specifically, transmittance was measured using a spectrophotometer U-4100 (manufactured by Hitachi, Ltd.), and values were calculated by multiplying a coefficient corresponding to solar light spectrum. The transmittance was measured for every 5 nm in a range of wavelength greater than or equal to 300 nm and less than or equal to 2100 nm. The solar transmittance is an index indicating the heat-ray shielding properties of the heat-ray shielding transparent substrate.

### Example 1

20 wt % of composite tungsten oxide particles (Cs_{0.33}WO₃: manufactured by Sumitomo Metal Mining CO., LTD.) as the heat-ray shielding particles, 10 wt % of acrylic-based polymer dispersant including a group containing amine as a functional group (amine value 48 mg KOH/g (hereinafter, referred to as “dispersant “a””)) and 70 wt % of methyl isobutyl ketone were weighed. The used composite tungsten oxide particles were composed of composite tungsten oxide Cs_{0.33}WO₃ having a hexagonal crystal structure. These were introduced in a paint shaker in which ZrO₂ beads of 0.3 mmφ were also introduced, and a crushing and dispersing process was performed for 15 hours to obtain a heat-ray shielding particle dispersing liquid (hereinafter, referred to as a “dispersing liquid “A””) containing Cs_{0.33}WO₃.

A heat-ray shielding particle dispersing liquid containing indium tin oxide particles (hereinafter, referred to as a “dispersing liquid “B””) was obtained by preparing the same composition as the dispersing liquid “A” except that the indium tin oxide particles (manufactured by Mitsubishi Materials Corporation) were used instead of the composite tungsten oxide particles and performing the crushing and dispersing process for 15 hours.

Here, the mean particle size of the composite tungsten oxide particles dispersed in the dispersing liquid “A” measured by a measurement apparatus for particle-size distribution (ELS-8000, manufactured by OTSUKA ELECTRONICS Co., LTD) was 80 nm. Further, the mean particle size of the indium tin oxide particles dispersed in the dispersing liquid “B” similarly measured was 85 nm.

Mixed dispersing liquid was prepared by mixing the obtained dispersing liquid “A” and the dispersing liquid “B” by the weight ratio of 40:60. Then, a coating liquid “A” was prepared by mixing 2 g of the mixed dispersing liquid and 1 g of acrylic-based ultraviolet curing resin (UV3701, manufactured by TOAGOSEI CO., LTD.) as the binder.

The coating liquid “A” was coated on a glass substrate (thickness of 3 mm) by a bar coater (No. 3) such that its visible light transmittance became 80±0.5%, dried at 70° C. for one minute and ultraviolet of greater than or equal to 250 mJ/cm² was irradiated. By these steps, a heat-ray shielding transparent substrate of example 1 was obtained in which a heat-ray shielding particle dispersing body as a coating layer was included on one surface of the glass substrate.

The thickness of the obtained coating layer of the heat-ray shielding transparent substrate was approximately 6 μm. The same bar coater was used in each of the following examples, the comparative examples and the reference example, and a coating layer of an approximately same thickness was formed in each of the following examples, the comparative examples and the reference example.

Further, the content (containing percentage) of the heat-ray shielding particles dispersedly contained in the coating layer of the obtained heat-ray shielding transparent substrate was 25 wt %. The content of the heat-ray shielding particles was the same in each of the following examples, the comparative examples and the reference example.

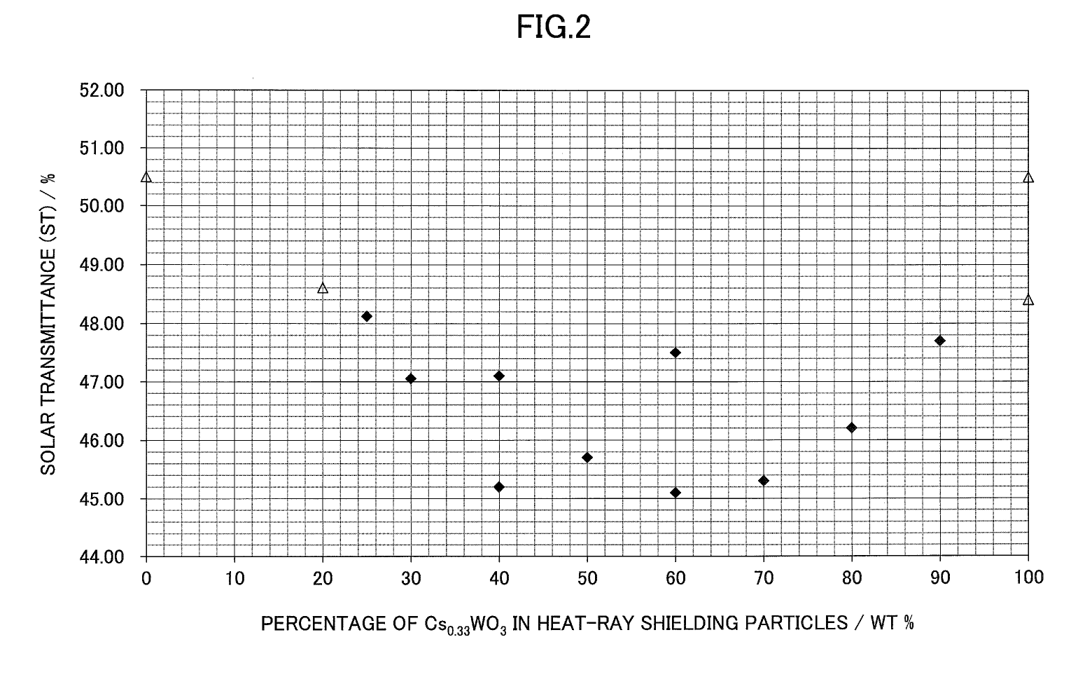

The visible light transmittance and the solar transmittance of the obtained heat-ray shielding transparent substrate were measured. The results are illustrated in Table,1 and FIG. 2.

### Example 2

10 wt % of the composite tungsten oxide particles (Cs_{0.33}WO₃:manufactured by Sumitomo Metal Mining CO., LTD.) as the heat-ray shielding particles, 10 wt % of the indium tin oxide particles (manufactured by Mitsubishi Materials Corporation), 10 wt % of the dispersant “a” and 70 wt % of methyl isobutyl ketone were weighed. These were introduced in a paint shaker in which ZrO₂ beads of 0.3 mmφ were also introduced, and a crushing and dispersing process was performed for 15 hours to obtain a heat-ray shielding particle dispersing liquid (hereinafter, referred to as a “dispersing liquid “C””) containing Cs_{0.33}WO₃ particles and the indium tin oxide particles. The mean particle size of the particles in the dispersing liquid “C” was 82 nm. Here, for the composite tungsten oxide particle and the indium tin oxide particles, materials same as those of example 1 were used.

2 g of the obtained dispersing liquid “C” and 1 g of the acrylic-based ultraviolet curing resin (UV3701, manufactured by TOAGOSEI CO., LTD.) as the binder were mixed to obtain a coating liquid “C”.

The coating liquid “C” was coated on the glass substrate (thickness of 3 mm) by the bar coater (No. 3) such that its visible light transmittance became 80±0.5%, dried at 70° C. for one minute and ultraviolet of greater than or equal to 250 mJ/cm² was irradiated. By these steps, a heat-ray shielding transparent substrate of example 2 was obtained in which the heat-ray shielding particle dispersing body as the coating layer was included on one surface of the glass substrate.

The visible light transmittance and the solar transmittance of the obtained heat-ray shielding transparent substrate were measured. The results are illustrated in Table 1 and FIG. 2.

### Examples 3 to 8

Heat-ray shielding transparent substrates of examples 3 to 8 in each of which the heat-ray shielding particle dispersing body as the coating layer was included on one surface of the glass substrate were obtained similarly as example 1 except that the weight ratio of the dispersing liquid “A” and the dispersing liquid “B” was changed as illustrated in Table 1.

The visible light transmittance and the solar transmittance of the obtained heat-ray shielding transparent substrates were measured. The results are illustrated in Table 1 and FIG. 2.

### Example 9

20 wt % of composite tungsten oxide particles (Rb_{0.33}WO₃: manufactured by Sumitomo Metal Mining CO., LTD.) as the heat-ray shielding particles, 10 wt % of “dispersant “a” and 70 wt % of methyl isobutyl ketone were weighed. The used composite tungsten oxide particles were composed of composite tungsten oxide Rb_{0.33}WO₃ having a hexagonal crystal structure. These were introduced in a paint shaker in which ZrO₂ beads of 0.3 mmφ were also introduced, and a crushing and dispersing process was performed for 18 hours to obtain a heat-ray shielding particle dispersing liquid (hereinafter, referred to as a “dispersing liquid “D””) containing Rb_{0.33}WO₃. The mean particle size of the particles in the dispersing liquid “D” was 89 nm.

Mixed dispersing liquid was prepared by mixing the obtained dispersing liquid “D” and the dispersing liquid “B” by the weight ratio of 40:60. Then, a coating liquid “E” was prepared by mixing 2 g of the mixed dispersing liquid and 1 g of acrylic-based ultraviolet curing resin (UV3701, manufactured by TOAGOSEI CO., LTD.) as the binder.

A heat-ray shielding transparent substrate was obtained in which the heat-ray shielding particle dispersing body as the coating layer was included on one surface of the glass substrate was obtained similarly as example 1 except that the coating liquid “A” was changed to the coating liquid “E”.

The visible light transmittance and the solar transmittance of the obtained heat-ray shielding transparent substrate were measured. The results are illustrated in Table 1 and FIG. 2.

### Example 10

A heat-ray shielding transparent substrate was obtained in which the heat-ray shielding particle dispersing body as the coating layer was included on one surface of the glass substrate was obtained similarly as example 9 except that the weight ratio of the dispersing liquid “D” and the dispersing liquid “B” was changed to 60:40.

The visible light transmittance and the solar transmittance of the obtained heat-ray shielding transparent substrate were measured. The results are illustrated in Table 1 and FIG. 2.

### Comparative Example 1

A heat-ray shielding transparent substrate of comparative example 1 in which the heat-ray shielding particle dispersing body as the coating layer was included on one surface of the glass substrate was obtained similarly as example 1 except that the heat-ray shielding particles were changed to only the composite tungsten oxide particles (Cs_{0.33}WO₃).

Specifically, 2 g of the dispersing liquid “A” and 1 g of ultraviolet curing resin (UV3701, manufactured by TOAGOSEI CO., LTD.) as the binder were mixed to obtain a coating liquid “A′”.

The coating liquid “A′” was coated on the glass substrate (thickness of 3 mm) by the bar coater (No. 3) such that its visible light transmittance became 80±0.5%, dried at 70° C. for one minute and ultraviolet of greater than or equal to 250 mJ/cm² was irradiated to obtain the heat-ray shielding transparent substrate.

The visible light transmittance and the solar transmittance of the obtained heat-ray shielding transparent substrate were measured. The results are illustrated in Table 1 and FIG. 2.

### Comparative Example 2

A heat-ray shielding transparent substrate of comparative example 2 in which the heat-ray shielding particle dispersing body as the coating layer was included on one surface of the glass substrate was obtained similarly as example 1 except that only the indium tin oxide particles were used as the heat-ray shielding particles.

Specifically, 2 g of the dispersing liquid “B” and 1 g of ultraviolet curing resin (UV3701, manufactured by TOAGOSEI CO., LTD.) as the binder were mixed to obtain a coating liquid “B′”.

The coating liquid “B′” was coated on the glass substrate (thickness of 3 mm) by the bar coater (No. 3) such that its visible light transmittance became 80±0.5%, dried at 70° C. for one minute and ultraviolet of greater than or equal to 250 mJ/cm² was irradiated to obtain the heat-ray shielding transparent substrate.

The visible light transmittance and the solar transmittance of the obtained heat-ray shielding transparent substrate were measured. The results are illustrated in Table 1 and FIG. 2.

### Reference Example

A heat-ray shielding transparent substrate was obtained similarly as example 1 except that a mixed liquid was used in which the obtained dispersing liquid “A” and the dispersing liquid “B” were mixed by the weight ratio of 2:8.

Specifically, a coating liquid “C′” was prepared by mixing 2 g of the mixed liquid and 1 g of ultraviolet curing resin (UV3701, manufactured by TOAGOSEI CO., LTD.) as the binder.

The coating liquid “C′” was coated on the glass substrate (thickness of 3 mm) by the bar coater (No. 3) such that its visible light transmittance became 80±0.5%, dried at 70° C. for one minute and ultraviolet of greater than or equal to 250 mJ/cm² was irradiated. As a result, the heat-ray shielding transparent substrate in which the heat-ray shielding particle dispersing body as the coating layer was included on one surface of the glass substrate was obtained.

The visible light transmittance and the solar transmittance of the obtained heat-ray shielding transparent substrate were measured. The results are illustrated in Table 1 and FIG. 2.

### Comparative Example 3

A heat-ray shielding transparent substrate of comparative example 1 in which the heat-ray shielding particle dispersing body as the coating layer was included on one surface of the glass substrate was obtained similarly as example 1 except that the heat-ray shielding particles were changed to only the composite tungsten oxide particles (Rb_{0.33}WO₃).

Specifically, 2 g of the dispersing liquid “D” and 1 g of ultraviolet curing resin (UV3701, manufactured by TOAGOSEI CO., LTD.) as the binder were mixed to obtain a coating liquid “D′”.

The coating liquid “D′” was coated on the glass substrate (thickness of 3 mm) by the bar coater (No. 3) such that its visible light transmittance became 80±0.5%, dried at 70° C. for one minute and ultraviolet of greater than or equal to 250 mJ/cm² was irradiated to obtain the heat-ray shielding transparent substrate.

The visible light transmittance and the solar transmittance of the obtained heat-ray shielding transparent substrate were measured. The results are illustrated in Table 1 and FIG. 2.

TABLE 1

| | | PERCENTAGE | PERCENTAGE | VISIBLE | |
|---|---|---|---|---|---|
| | | OF Cs_{0.33}WO₃ IN | OF ITO IN | LIGHT | SOLAR |
| | | HEAT-RAY | HEAT-RAY | TRANSMIT- | TRANSMIT- |
| | DISPERSING | SHIELDING | SHIELDING | TANCE | TANCE |
| | LIQUID | PARTICLES/WT % | PARTICLES/WT % | (VLT)/% | (ST)/% |
| EXAMPLE 1 | A:B = 40:60 | 40 | 60 | 79.7 | 45.20 |
| EXAMPLE 2 | C | 50 | 50 | 80.2 | 45.70 |
| EXAMPLE 3 | A:B = 60:40 | 60 | 40 | 79.7 | 45.10 |
| EXAMPLE 4 | A:B = 70:30 | 70 | 30 | 79.7 | 45.30 |
| EXAMPLE 5 | A:B = 80:20 | 80 | 20 | 79.8 | 46.20 |
| EXAMPLE 6 | A:B = 90:10 | 90 | 10 | 80.3 | 47.70 |
| EXAMPLE 7 | A:B = 30:70 | 30 | 70 | 79.8 | 47.05 |
| EXAMPLE 8 | A:B = 25:75 | 25 | 75 | 80.5 | 48.12 |
| EXAMPLE 9 | D:B = 40:60 | 40 | 60 | 80.0 | 47.10 |
| EXAMPLE 10 | D:B = 60:40 | 60 | 40 | 79.8 | 47.50 |
| COMPARATIVE | A | 100 | 0 | 80.4 | 48.40 |
| EXAMPLE 1 | | | | | |
| COMPARATIVE | B | 0 | 100 | 80.1 | 50.50 |
| EXAMPLE 2 | | | | | |
| REFERENCE | A:B = 20:80 | 20 | 80 | 80.4 | 48.60 |
| EXAMPLE | | | | | |
| COMPARATIVE | D | 100 | 0 | 80.1 | 50.50 |
| EXAMPLE 3 | | | | | |

FIG. 2 is a graph illustrating a relationship between the percentage of the composite tungsten oxide particles (Cs_{0.33}WO₃ or Rb_{0.33}WO₃) in the heat-ray shielding particles and the solar transmittance of each of the examples, the comparative examples and the reference example illustrated in Table 1. In FIG. 2, a result of each of example 1 to example 10 is illustrated by a black diamond, and a result of each of comparative examples 1 to 3 and the reference example is illustrated by a white triangle.

As can be understood from the results illustrated in Table 1 and FIG. 2, it was confirmed that the solar transmittance was reduced for each of example 1 to example 10 in which the weight ratio of the composite tungsten oxide particles and the indium tin oxide particles in the heat-ray shielding particles is within a range of “composite tungsten oxide particles”/“indium tin oxide particles”=99/1 to 22/78, compared with comparative examples 1 to 3 in each of which only either one of the composite tungsten oxide particles and the indium tin oxide particles were used as the heat-ray shielding particles.

As illustrated in Table 1, the visible light transmittance in each of example 1 to example 10 can be retained as same as that of each of comparative examples 1 to 3 in which only either one of the composite tungsten oxide particles and the indium tin oxide particles were used as the heat-ray shielding particles. In other words, it was confirmed that the high visible light transmittance was obtained in each of example 1 to example 10.

Further, in reference example, both the composite tungsten oxide particles and the indium tin oxide particles were used as the heat-ray shielding particles. Here, the solar transmittance was reduced compared with that of comparative example 2 in which only the indium tin oxide particles were used as the heat-ray shielding particles. However, the weight ratio of the composite tungsten oxide particles and the indium tin oxide particles in the heat-ray shielding particles was not within the range of “composite tungsten oxide particles”/“indium tin oxide particles”=99/1 to 22/78, and an effect of reducing the solar transmittance was not obtained compared with comparative example 1 in which only the composite tungsten oxide particles were used as the heat-ray shielding particles.

From the above results, it was confirmed that the heat-ray shielding particles whose visible light transmittance was high while whose solar transmittance was reduced were obtained when the weight ratio of the composite tungsten oxide particles and the indium tin oxide particles was within a range of “composite tungsten oxide particles”/“indium tin oxide particles”=99/1 to 22/78.

Further, the coating layer containing the heat-ray shielding particles, in other words, the heat-ray shielding transparent substrate containing the heat-ray shielding particle dispersing body was exemplified in the above examples. However, the heat-ray shielding laminated transparent substrate may be manufactured by further placing a transparent substrate on the coating layer, for example. In such a case as well, properties same as those described above regarding the heat-ray shielding transparent substrate can be obtained.

According to the embodiment, a heat-ray shielding particle dispersing liquid containing heat-ray shielding particles whose visible light transmittance is high while whose solar transmittance is reduced can be provided.

Although a preferred embodiment of the heat-ray shielding particle dispersing liquid, the heat-ray shielding particle dispersing body, the heat-ray shielding laminated transparent substrate and the heat-ray shielding transparent substrate has been specifically illustrated and described, it is to be understood that minor modifications may be made therein without departing from the spirit and scope of the invention as defined by the claims.

The present invention is not limited to the specifically disclosed embodiments, and numerous variations and modifications may be made without departing from the spirit and scope of the present invention.

What is claimed is:

1. A heat-ray shielding particle dispersing liquid comprising:
heat-ray shielding particles at least containing composite tungsten oxide particles and indium tin oxide particles, the weight ratio of the composite tungsten oxide particles and the indium tin oxide particles in the heat-ray shielding particles being within a range of “composite tungsten oxide particles”/“indium tin oxide particles”=99/1 to 22/78; and
a liquid medium.

2. The heat-ray shielding particle dispersing liquid according to claim 1, wherein the composite tungsten oxide particles include composite tungsten oxide having a hexagonal crystal structure.

3. The heat-ray shielding particle dispersing liquid according to claim 1, wherein the composite tungsten oxide particles are one or more types selected from cesium tungsten oxide particles, rubidium tungsten oxide particles and potassium tungsten oxide particles.

4. The heat-ray shielding particle dispersing liquid according to claim 1, wherein the liquid medium is one or more types selected from water, organic solvent, fat and oil, liquid resin and plasticizer.

5. The heat-ray shielding particle dispersing liquid according to claim 1, further comprising:
one or more types selected from dispersant, a coupling agent and a surface active agent.

6. The heat-ray shielding particle dispersing liquid according to claim 1, wherein the weight ratio of the composite tungsten oxide particles and the indium tin oxide particles in the heat-ray shielding particles is within a range of “composite tungsten oxide particles”/“indium tin oxide particles”=85/15 to 30/70.

7. A heat-ray shielding particle dispersing body comprising:
heat-ray shielding particles at least containing composite tungsten oxide particles and indium tin oxide particles, the weight ratio of the composite tungsten oxide particles and the indium tin oxide particles in the heat-ray shielding particles being within a range of “composite tungsten oxide particles”/“indium tin oxide particles”=99/1 to 22/78; and
a binder.

8. The heat-ray shielding particle dispersing body according to claim 7, wherein the composite tungsten oxide particles include composite tungsten oxide having a hexagonal crystal structure.

9. The heat-ray shielding particle dispersing body according to claim 7, wherein the binder is one or more types selected from thermoplastic resin, thermosetting resin and ultraviolet curing resin.

10. The heat-ray shielding particle dispersing body according to claim 9, wherein the thermoplastic resin is one type of resin selected from a resin group including polyethylene terephthalate resin, polycarbonate resin, acrylic resin, styrene resin, polyamide resin, polyethylene resin, vinyl chloride resin, olefin resin, epoxy resin, polyimide resin, fluororesin, ethylene-vinyl acetate copolymer and polyvinyl acetal resin, a mixture of two or more types of resins selected from the resin group, or a copolymer of two or more types of resins selected from the resin group.

11. The heat-ray shielding particle dispersing body according to claim 7, wherein the content of the heat-ray shielding particles is greater than or equal to 0.001 wt % and less than or equal to 80.0 wt %.

12. The heat-ray shielding particle dispersing body according to claim 7, wherein the heat-ray shielding particle dispersing body has a sheet shape, a board shape or a film shape.

13. A heat-ray shielding laminated transparent substrate comprising:
a plurality of transparent substrates; and
the heat-ray shielding particle dispersing body according to claim 7,
wherein the heat-ray shielding particle dispersing body is positioned between the plurality of the transparent substrates.

14. The heat-ray shielding laminated transparent substrate according to claim 13, wherein at least one of the plurality of the transparent substrates is a glass substrate.

15. The heat-ray shielding laminated transparent substrate according to claim 13,
wherein visible light transmittance is greater than or equal to 70%, and
wherein solar transmittance is lower than solar transmittance of a comparative heat-ray shielding laminated transparent substrate in which only the composite tungsten oxide particles are used as heat-ray shielding particles, and whose visible light transmittance is the same.

16. A heat-ray shielding transparent substrate comprising:
a transparent substrate which is a resin substrate or a glass substrate; and
a coating layer including heat-ray shielding particles and a binder, the heat-ray shielding particles at least containing composite tungsten oxide particles and indium tin oxide particles, the weight ratio of the composite tungsten oxide particles and the indium tin oxide particles in the heat-ray shielding particles being within a range of “composite tungsten oxide particles”/“indium tin oxide particles”=99/1 to 22/78.

17. The heat-ray shielding transparent substrate according to claim 16, wherein the composite tungsten oxide particles include composite tungsten oxide having a hexagonal crystal structure.

18. The heat-ray shielding transparent substrate according to claim 16, wherein the binder is ultraviolet curing resin.

19. The heat-ray shielding transparent substrate according to claim 16, wherein the thickness of the coating layer is less than or equal to 10 μm.

20. The heat-ray shielding transparent substrate according to claim 16, wherein the transparent substrate is a resin substrate, and the resin substrate is a polyester film.
